(19) United States
(12) Patent Application Publication
(10) Pub. No.: US 2015/0187284 A1
(43) Pub. Date: Jul. 2, 2015

(54) METHOD FOR PREVENTING UNEVEN BRIGHTNESS IN STEREOSCOPIC DISPLAY DEVICE

(71) Applicants: Bin Fang, Shenzhen (CN); Chihming Yang, Shenzhen (CN)

(72) Inventors: Bin Fang, Shenzhen (CN); Chihming Yang, Shenzhen (CN)

(73) Assignee: Shenzhen China Star Optoelectronics Technology Co., Ltd., Shenzhen (CN)

(21) Appl. No.: 14/233,763

(22) PCT Filed: Jan. 7, 2014
(86) PCT No.: PCT/CN2014/070204

§ 371 Date: Jan. 20, 2014

(30) Foreign Application Priority Data
Dec. 31, 2013 (CN) 201310750128.5

(51) Int. Cl. G09G 3/34

(52) U.S. Cl. CPC G09G 3/3406; G09G 2320/0233

(57) ABSTRACT

A method for preventing uneven brightness in the stereoscopic display device is disclosed. The method for preventing the uneven brightness in the stereoscopic display device needs only one gamma voltage curve. By utilizing two white tracking look-up tables for respectively adjusting voltage division of left-eye images and right-eye images, the stereoscopic display device solves not only the problem of the 3D image sticking but also the problem of the uneven brightness in different frames.

### BACKGROUND OF THE INVENTION

1. Field of the Invention

The present invention generally relates to a stereoscopic display device, and more particularly to a method for preventing uneven brightness in a stereoscopic display device.

2. Description of Prior Art

With the development of liquid crystal display devices, stereoscopic display devices (3D display devices) capable of displaying stereoscopic images have entered the market gradually and become a development direction of the liquid crystal display devices in the next generation.

Shutter glasses are a type of active shutter stereoscopic display technology. A frequency of the shutter glasses is usually at 60 hertz (Hz), and a screen refresh rate of a liquid crystal display device is at 120 Hz or 240 Hz.

Since a response time of the liquid crystal display device is slower (greater than 3 milliseconds) and the liquid crystal display device usually adopts a holding-type driving method, the active shutter stereoscopic display technology needs to match with a backlight scanning technology or a backlight blinking technology.

Please refer to FIG. 1 to FIG. 3. FIG. 1 illustrates that white images (i.e. a gray level of L255) serve as left-eye images and black images (i.e. a gray level of L0) serve as right-eye image in the conventional shutter stereoscopic display technology.

FIG. 2 illustrates voltages representing the gray level of L0 in FIG. 1. FIG. 3 illustrates voltages representing the gray level of L255 in FIG. 1.

The shutter stereoscopic display technology in FIG. 1 is driven with a one-frame polarity inversion. That is, polarities are inverted every one frame. Accordingly, the left-eye images (including the frame 1, the frame 3, the frame 5, the frame 7, and the frame 9) are driven with a positive polarity voltage, and the right-eye images (including the frame 2, the frame 4, the frame 6, and the frame 8) are driven with a negative polarity voltage. As shown in FIG. 2, a voltage difference between a positive polarity voltage V+ of the gray level of L0 and a common voltage VCOM and a voltage difference between a negative polarity voltage V− of the gray level of L and the common voltage VCOM are small. As shown in FIG. 3, a voltage difference between a positive polarity voltage V+′ of the gray level of L255 and the common voltage VCOM and a voltage difference between a negative polarity voltage V−′ of the gray level of L255 and the common voltage VCOM are large. Since the left-eye images (including the frame 1, the frame 3, the frame 5, the frame 7, and the frame 9) are driven with the positive polarity voltage and the right-eye images (including the frame 2, the frame 4, the frame 6, and the frame 8) are driven with the negative polarity voltage, any one position of the liquid crystal display device is driven with the same polarity voltage, which results in 3D image sticking.

Please refer to FIG. 4. FIG. 4 illustrates a shutter stereoscopic display technology for preventing the above-mentioned 3D image sticking. The shutter stereoscopic display technology in FIG. 4 is driven with a two-frame polarity inversion. That is, polarities are inverted every two frames. Accordingly, the left-eye images (including the frame 1, the frame 3, the frame 5, the frame 7, and the frame 9) are driven with a positive polarity voltage and a negative polarity voltage which are alternate, and the right-eye images (including the frame 2, the frame 4, the frame 6, and the frame 8) are driven with a positive polarity voltage and a negative polarity voltage which are alternate, thereby preventing the 3D image sticking.

Please refer to FIG. 5. FIG. 5 illustrates a brightness of a pixel in frames when the white images (i.e. the gray level of L255) serve as the left-eye images and the right-eye images. Since the two-frame polarity inversion and a low color washout design are used in FIG. 4, the brightness of the pixel is bright when the pixel is driven with the same polarity voltages in a current frame and in a previous frame, such as the frame 2, the frame 4, the frame 6, and the frame 8. The brightness of the pixel is dark when the pixel is driven with opposite polarity voltages in the current frame and in the previous frame, such as the frame 1, the frame 3, the frame 5, the frame 7, and the frame 9. As a result, although the problem of the 3D image sticking can be solved when 3D images are displayed with the two-frame polarity inversion, the problem of uneven brightness occurs in different frames.

Consequently, there is a need to solve the problem of the uneven brightness in different frames when 3D images are displayed with the two-frame polarity inversion in the prior art.

### SUMMARY OF THE INVENTION

An objective of the present invention is to provide a method for preventing uneven brightness in a stereoscopic display device capable of solving the problem of the uneven brightness in the prior art.

To solve the above-mentioned problem, a method for preventing uneven brightness in a stereoscopic display device provided by the present invention is driven with a two-frame polarity inversion. The method for preventing the uneven brightness in the stereoscopic display device comprises: generating a plurality of gamma voltages according to a gamma voltage curve; receiving an original gray level data; looking up gray levels of a plurality of colors from a first white tracking look-up table according to the original gray level data when the original gray level data is a gray level data of a left-eye image; looking up the gray levels of the colors from a second white tracking look-up table when the original gray level data is a gray level data of a right-eye image; and displaying a gray level corresponding to the original gray level data according to the gray levels of the colors. A number of the gamma voltages is less than a number of displayable gray levels of the stereoscopic display device. The first white tracking look-up table and the second white tracking look-up table store corresponding relationships of the original gray level data versus the gray levels of the colors.

In the method for preventing the uneven brightness in the stereoscopic display device of the present invention, the gray levels of the colors at least comprise a gray level of a first color, a gray level of a second gray level, and a gray level of a third color.

In the method for preventing the uneven brightness in the stereoscopic display device of the present invention, the first color is red, the second color is green, and the third color is blue.

To solve the above-mentioned problem, a method for preventing uneven brightness in a stereoscopic display device provided by the present invention is driven with a two-frame polarity inversion. The method for preventing the uneven brightness in the stereoscopic display device comprises: generating a plurality of gamma voltages according to a gamma voltage curve; receiving an original gray level data; looking up gray levels of a plurality of colors from a first white tracking look-up table according to the original gray level data when the original gray level data is a gray level data of a left-eye image; looking up the gray levels of the colors from a second white tracking look-up table when the original gray level data is a gray level data of a right-eye image; and displaying a gray level corresponding to the original gray level data according to the gray levels of the colors.

In the method for preventing the uneven brightness in the stereoscopic display device of the present invention, a number of the gamma voltages is less than a number of displayable gray levels of the stereoscopic display device.

In the method for preventing the uneven brightness in the stereoscopic display device of the present invention, the first white tracking look-up table and the second white tracking look-up table store corresponding relationships of the original gray level data versus the gray levels of the colors.

In the method for preventing the uneven brightness in the stereoscopic display device of the present invention, the gray levels of the colors at least comprise a gray level of a first color, a gray level of a second gray level, and a gray level of a third color.

In the method for preventing the uneven brightness in the stereoscopic display device of the present invention, the first color is red, the second color is green, and the third color is blue.

To solve the above-mentioned problem, a method for preventing uneven brightness in a stereoscopic display device provided by the present invention is driven with a two-frame polarity inversion. The method for preventing the uneven brightness in the stereoscopic display device comprises: generating a plurality of gamma voltages according to a gamma voltage curve; receiving an original gray level data; determining whether the original gray level data is a gray level data of a left-eye image or a gray level data of a right-eye image; and looking up gray levels of a plurality of colors from a first white tracking look-up table or a second white tracking look-up table according to the determination result.

In the method for preventing the uneven brightness in the stereoscopic display device of the present invention, a number of the gamma voltages is less than a number of displayable gray levels of the stereoscopic display device.

In the method for preventing the uneven brightness in the stereoscopic display device of the present invention, the first white tracking look-up table and the second white tracking look-up table store corresponding relationships of the original gray level data versus the gray levels of the colors.

In the method for preventing the uneven brightness in the stereoscopic display device of the present invention, the gray levels of the colors at least comprise a gray level of a first color, a gray level of a second gray level, and a gray level of a third color.

In the method for preventing the uneven brightness in the stereoscopic display device of the present invention, the first color is red, the second color is green, and the third color is blue.

Compared with the prior arts, the method for preventing the uneven brightness in the stereoscopic display device of the present invention solves not only the problem of the 3D image sticking but also the problem of the uneven brightness in different frames.

For a better understanding of the aforementioned content of the present invention, preferable embodiments are illustrated in accordance with the attached figures for further explanation:

### BRIEF DESCRIPTION OF THE DRAWINGS

FIG. 1 illustrates that white images serve as left-eye images and black images serve as right-eye image in the conventional shutter stereoscopic display technology;

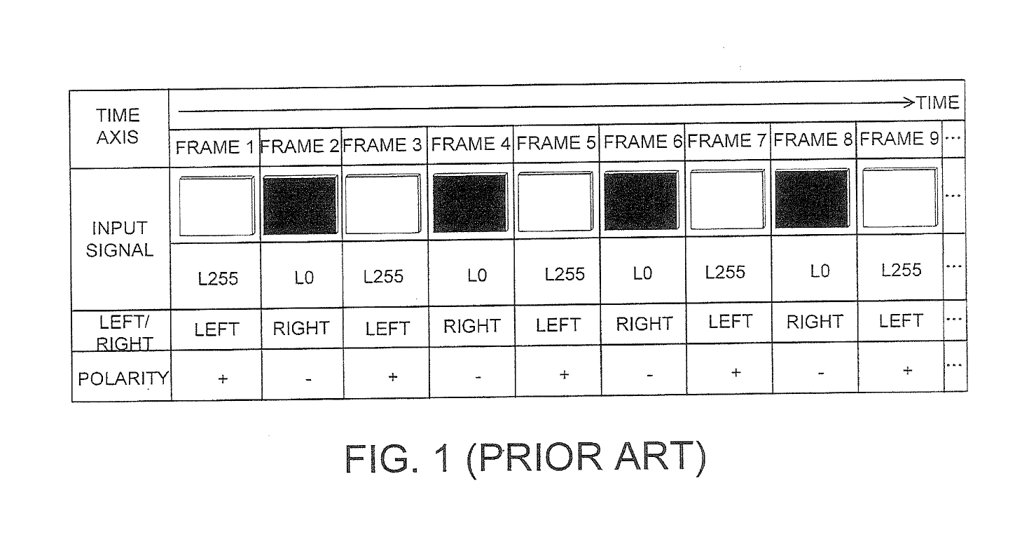

FIG. 2 illustrates voltages representing the gray level of L0 in FIG, 1;

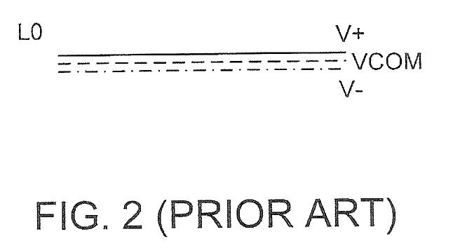

FIG. 3 illustrates voltages representing the gray level of L255 in FIG. 1;

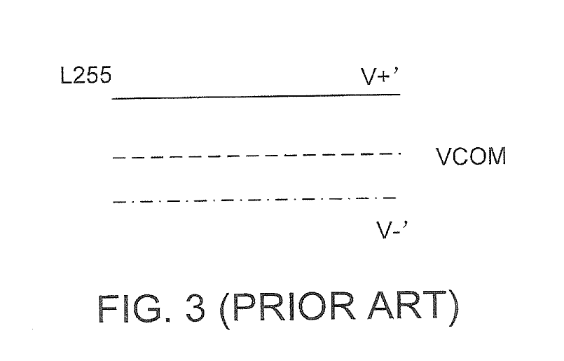

FIG. 4 illustrates a shutter stereoscopic display technology for preventing the 3D image sticking;

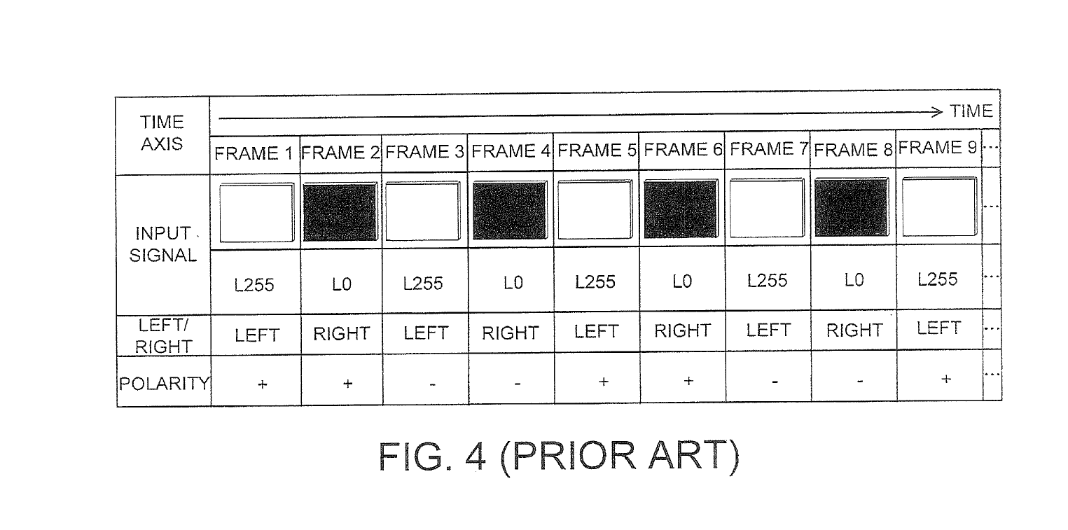

FIG. 5 illustrates a brightness of a pixel in frames when the white images serve as the left-eye images and the right-eye images;

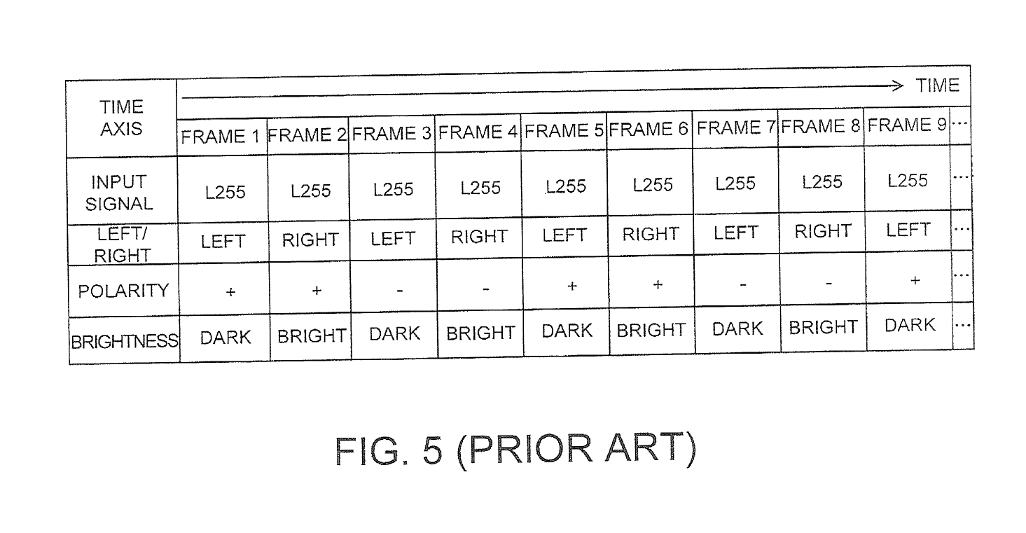

FIG. 6 illustrates a flowchart of a method for preventing uneven brightness in a stereoscopic display device in accordance with an embodiment of the present invention;

FIG. 7 illustrates a brightness of a pixel in frames when white images serve as left-eye images and right-eye images; and

FIG. 8 illustrates an example of a white tracking look-up table.

### DETAILED DESCRIPTION OF THE INVENTION

The following descriptions for the respective embodiments are specific embodiments capable of being implemented for illustrations of the present invention with reference to the appended figures.

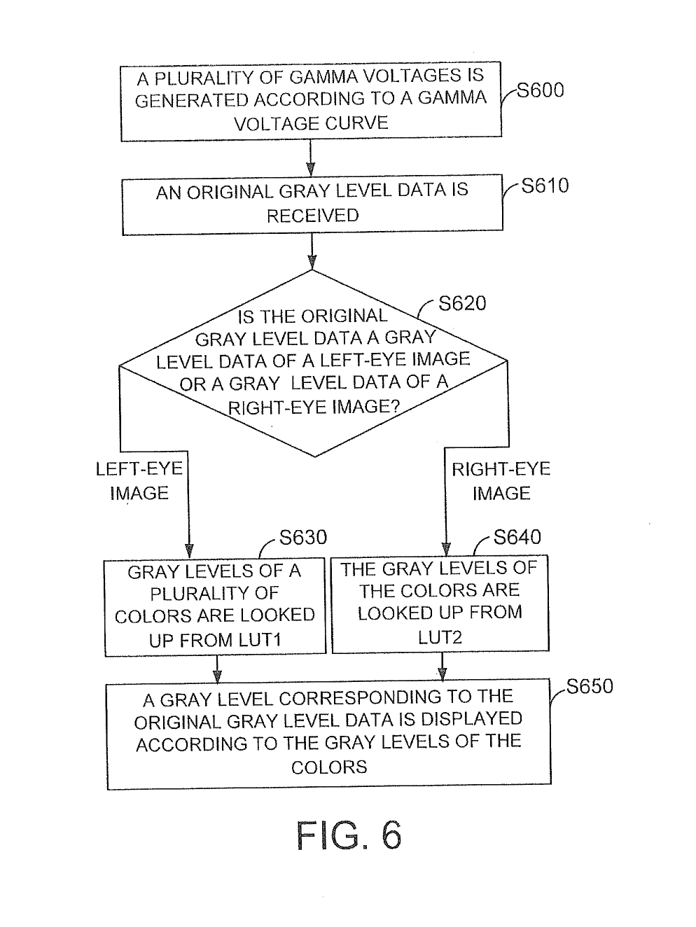

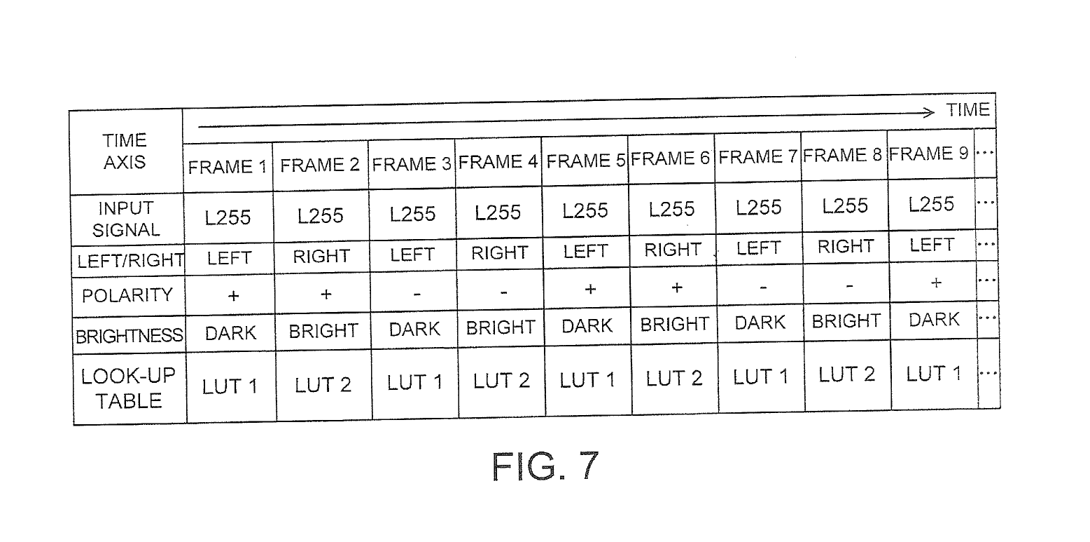

Please refer to FIG. 6 and FIG. 7. FIG. 6 illustrates a flowchart of a method for preventing uneven brightness in a stereoscopic display device in accordance with an embodiment of the present invention. FIG. 7 illustrates a brightness of a pixel in frames when white images (i.e. the gray level of L255) serve as left-eye images and right-eye images.

The stereoscopic display device is driven with a two-frame polarity inversion. That is, polarities are inverted every two frames. Accordingly, the frame 1, the frame 3, the frame 5, the frame 7, and the frame 9 for displaying the left-eye images are driven with a positive polarity voltage and a negative polarity voltage which are alternate, and the frame 2, the frame 4, the frame 6, and the frame 8 for displaying the right-eye images are driven with the positive polarity voltage and the negative polarity voltage which are alternate, as shown in FIG. 7. Therefore, the problem of the 3D image sticking can be prevented. More particularly, the stereoscopic display device is utilized for alternately displaying the left-eye images and the right-eye images. In the present embodiment, the left-eye images are displayed in odd frames, and the right-eye images are displayed in even frames.

In step S600, a plurality of gamma voltages is generated according to a gamma voltage curve. A number of the gamma voltages is less than a number of displayable gray levels of the stereoscopic display device. In the embodiment in FIG. 7, the number of the displayable gray levels is 256.

In step S610, an original gray level data is received. The original gray level data is a gray level of a left-eye image or a right-eye image to be displayed. In the embodiment in FIG. 7, the gray level may be one between the gray level L0 and the gray level L255.

In step S620, the original gray level data is determined as a gray level data of a left-eye image or a gray level data of a right-eye image. When the original gray level data is determined as the gray level data of the left-eye image, step S630 is performed. When the original gray level data is determined as the gray level data of the right-eye image, step S640 is performed.

In step S630, gray levels of a plurality of colors are looked up from a first white tracking look-up table (LUT1). Then, step S650 is performed.

In step S640, the gray levels of the colors are looked up from a second white tracking look-up table (LUT2). Then, step S650 is performed.

The gray levels of the colors at least comprise a gray level of a first color, a gray level of a second gray level, and a gray level of a third color. In one embodiment, the first color is red, the second color is green, and the third color is blue. In another embodiment, the colors may be other colors.

In step S650, a gray level corresponding to the original gray level data is displayed according to the gray levels of the colors.

As mentioned above, since the number of the gamma voltages is less than the number of the displayable gray levels of the stereoscopic display device, the first white tracking look-up table and the second white tracking look-up table are utilized for storing corresponding relationships of the original gray level data versus the gray levels of the colors according to the gamma voltages. More particularly, the first white tracking look-up table and the second white tracking look-up table can make the gamma voltages correspond to the displayable gray levels by dividing the gamma voltages.

The method for preventing the uneven brightness in the stereoscopic display device of the present invention needs only one gamma voltage curve (step S600). By utilizing two white tracking look-up tables for respectively adjusting voltage division of the left-eye images and the right-eye images, the stereoscopic display device solves not only the problem of the 3D image sticking but also the problem of the uneven brightness in different frames. More particularly, the stereoscopic display device can display 256 gray levels by dividing the gamma voltages according to the white tracking look-up tables.

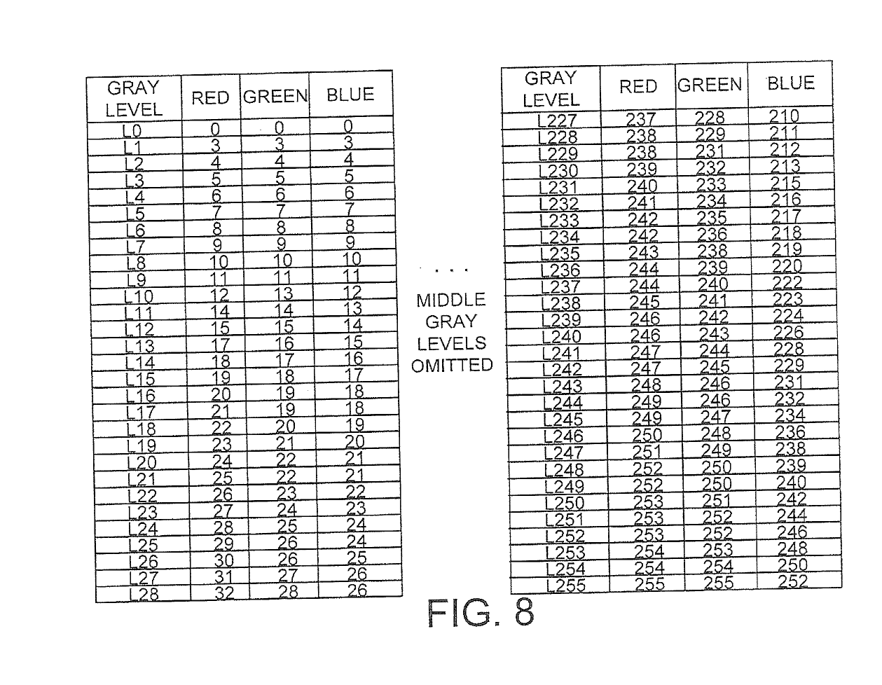

Please refer to FIG. 8. FIG. 8 illustrates an example of a white tracking look-up table. The white tracking look-up table is utilized for adjusting the gray levels according to the gray levels of the colors. For example, when the gray level L235 is required to be displayed, the gray level of red is 243, the gray level of green is 238, and the gray level of blue is 219. As a result, the images have good chrominance, and the images displayed in the frames have even brightness.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structures.

What is claimed is:

1. A method for preventing uneven brightness in a stereoscopic display device, the stereoscopic display device driven with a two-frame polarity inversion, the method for preventing the uneven brightness in the stereoscopic display device comprising:
generating a plurality of gamma voltages according to a gamma voltage curve;
receiving an original gray level data;
looking up gray levels of a plurality of colors from a first white tracking look-up table according to the original gray level data when the original gray level data is a gray level data of a left-eye image;
looking up the gray levels of the colors from a second white tracking look-up table when the original gray level data is a gray level data of a right-eye image; and
displaying a gray level corresponding to the original gray level data according to the gray levels of the colors,
wherein a number of the gamma voltages is less than a number of displayable gray levels of the stereoscopic display device, and the first white tracking look-up table and the second white tracking look-up table store corresponding relationships of the original gray level data versus the gray levels of the colors.

2. The method for preventing the uneven brightness in the stereoscopic display device of claim 1, wherein the gray levels of the colors at least comprise a gray level of a first color, a gray level of a second gray level, and a gray level of a third color.

3. The method for preventing the uneven brightness in the stereoscopic display device of claim 2, wherein the first color is red, the second color is green, and the third color is blue.

4. A method for preventing uneven brightness in a stereoscopic display device, the stereoscopic display device driven with a two-frame polarity inversion, the method for preventing the uneven brightness in the stereoscopic display device comprising:
generating a plurality of gamma voltages according to a gamma voltage curve;
receiving an original gray level data;
looking up gray levels of a plurality of colors from a first white tracking look-up table according to the original gray level data when the original gray level data is a gray level data of a left-eye image;
looking up the gray levels of the colors from a second white tracking look-up table when the original gray level data is a gray level data of a right-eye image; and
displaying a gray level corresponding to the original gray level data according to the gray levels of the colors.

5. The method for preventing the uneven brightness in the stereoscopic display device of claim 4, wherein a number of the gamma voltages is less than a number of displayable gray levels of the stereoscopic display device,

6. The method for preventing the uneven brightness in the stereoscopic display device of claim 4, wherein the first white tracking look-up table and the second white tracking look-up table store corresponding relationships of the original gray level data versus the gray levels of the colors.

7. The method for preventing the uneven brightness in the stereoscopic display device of claim 4, wherein the gray levels of the colors at least comprise a gray level of a first color, a gray level of a second gray level, and a gray level of a third color,

8. The method for preventing the uneven brightness in the stereoscopic display device of claim 7, wherein the first color is red, the second color is green, and the third color is blue.

9. A method for preventing uneven brightness in a stereoscopic display device, the stereoscopic display device driven with a two-frame polarity inversion, the method for preventing the uneven brightness in the stereoscopic display device comprising:
generating a plurality of gamma voltages according to a gamma voltage curve;
receiving an original gray level data;
determining whether the original gray level data is a gray level data of a left-eye image or a gray level data of a right-eye image; and
looking up gray levels of a plurality of colors from a first white tracking look-up table or a second white tracking look-up table according to the determination result.

10. The method for preventing the uneven brightness in the stereoscopic display device of claim 9, wherein a number of the gamma voltages is less than a number of displayable gray levels of the stereoscopic display device.

11. The method for preventing the uneven brightness in the stereoscopic display device of claim 9, wherein the first white tracking look-up table and the second white tracking look-up table store corresponding relationships of the original gray level data versus the gray levels of the colors.

12. The method for preventing the uneven brightness in the stereoscopic display device of claim 9, wherein the gray levels of the colors at least comprise a gray level of a first color, a gray level of a second gray level, and a gray level of a third color.

13. The method for preventing the uneven brightness in the stereoscopic display device of claim 12, wherein the first color is red, the second color is green, and the third color is blue.
